(19) United States
(12) Patent Application Publication
(10) Pub. No.: US 2015/0229128 A1
(43) Pub. Date: Aug. 13, 2015

(54) METHOD OF MANAGING ELECTRIC POWER, POWER MANAGEMENT DEVICE, AND PROGRAM

(71) Applicant: NEC CORPORATION, Minato-ku, Tokyo (JP)

(72) Inventor: Youjirou Nomura, Tokyo (JP)

(73) Assignee: NEC Corporation

(21) Appl. No.: 14/427,387

(22) PCT Filed: Sep. 12, 2013
(86) PCT No.: PCT/JP2013/074731

§ 371 Date: Mar. 11, 2015

(30) Foreign Application Priority Data
Sep. 12, 2012 (JP) 2012-200415

(51) Int. Cl. H02J 3/00; H01L 31/04; G05B 15/02

(52) U.S. Cl. CPC H02J 3/00; G05B 15/02; H02S 10/00

(57) ABSTRACT

This method of managing electric power electric power for managing power supply to users within a group from a power storage system and power supply to the users from a grid, the method includes obtaining a power consumed by the users (referred to as “load power”) and a peak cut power in the group; deciding a power to be discharged from the power storage system in each time segment by using at least the load power and the peak cut power; and deciding an index indicating how much grid power has been previously consumed within the group (referred to as a “grid power consumption index”), wherein in the step of determining a power to be discharged from the power storage system, a power to be discharged from the power storage system is decided by using all of the grid power consumption index, the load power, and the peak cut power.

### TECHNICAL FIELD

The present invention relates to an art for managing power supply to users in a certain group for example, and more particularly to a method of managing electric power, a power management device and a program, which allows grid power supplied to a group to be flattened in a certain time range by totally managing electric power within the group.

### BACKGROUND ART

In recent years, it is proposed that, regarding power supply to residences and buildings among other things, supply control of power is performed using IT (information technology) technology and that power storage system in addition to the grid power from a power plant is used. For example, Patent Document 1 discloses disposing photovoltaic power generator and power storage system in a residence, outputting power from the photovoltaic power generator to an external power system, and using the power for charging the power storage system.

### PRIOR ART REFERENCE

Patent Document 1: Japanese Patent Laid-Open No. 2011-078168

### SUMMARY OF INVENTION

### Technical Problem

Although Patent Document 1 discloses managing individual electric power for each residence, it does not focus on total electric power management in an area. Meanwhile, to reduce load of a power plant which administers the region, it is desirable to totally manage electric power in the whole region and control grid power required in the region, power from the power storage system, or the like, instead of individually managing power for each house or each building. Particularly, even when the much grid power is consumed intensively in a region, it is preferable that the grid power can be flattened in a certain time range, so that load on power plant can be reduced.

To address the problem, an object of the present invention is to provide a method of managing electric power, a power management device and a program, which allows grid power supplied to a group to be flattened in a certain time range by totally managing electric power within the group.

### Solution to Problem

To achieve the above-described object, a method of managing electric power according to one aspect of the present invention is as follows:
1. A method of managing electric power for managing power supply to users within a group from a power storage system and power supply to the users from a grid, the method comprising:

obtaining a power consumed by the users (referred to as “load power”) and a peak cut power in the group;

deciding a power to be discharged from the power storage system in each time segment by using at least the load power and the peak cut power; and

deciding an index indicating how much grid power has been previously consumed within the group (referred to as a “grid power consumption index”),

wherein in step of determining a power to be discharged from the power storage system, the power to be discharged from the power storage system is decided by using all of the grid power consumption index, the load power, and the peak cut power.

### Description of Terms

As the “users”, residences, buildings, commercial facilities, industrial facilities, medical facilities or the like are included.

As to “time segments”, length of one time segment can be arbitrarily configured, and, for example, the length of one time segment may be several minutes to several tens of minutes, an hour or the like. Moreover, each time segment is not needed to be constant.

### Advantage of the Invention

According to the present invention, it is possible to provide a method of managing electric power, a power management device and a program, which allows grid power supplied to a group to be flattened in a certain time range by totally managing electric power within the group.

### BRIEF DESCRIPTION OF THE DRAWINGS

FIG. 1 is a schematic diagram illustrating an electric power management system according to an embodiment of the present invention.

FIG. 2 is a block diagram illustrating one example of an configuration of a power management device.

FIG. 3 is a flowchart illustrating a series of operation of the system in FIG. 1.

FIG. 4 is a graph illustrating (i) change of load power for each time segment within a group, and (ii) a power supply ratio of power from a photovoltaic power generator, power from a power storage system and power from a grid with respect to the load power.

FIG. 5 is a graph illustrating a power supply ratio and the like, for each time segment when conventional power management is performed.

### DESCRIPTION OF EMBODIMENTS

Embodiments of the present invention are described with reference to the drawings. It is noted that configurations, functions, operations and the like described below are according to an embodiment of the present invention and are not intended to limit the present invention.

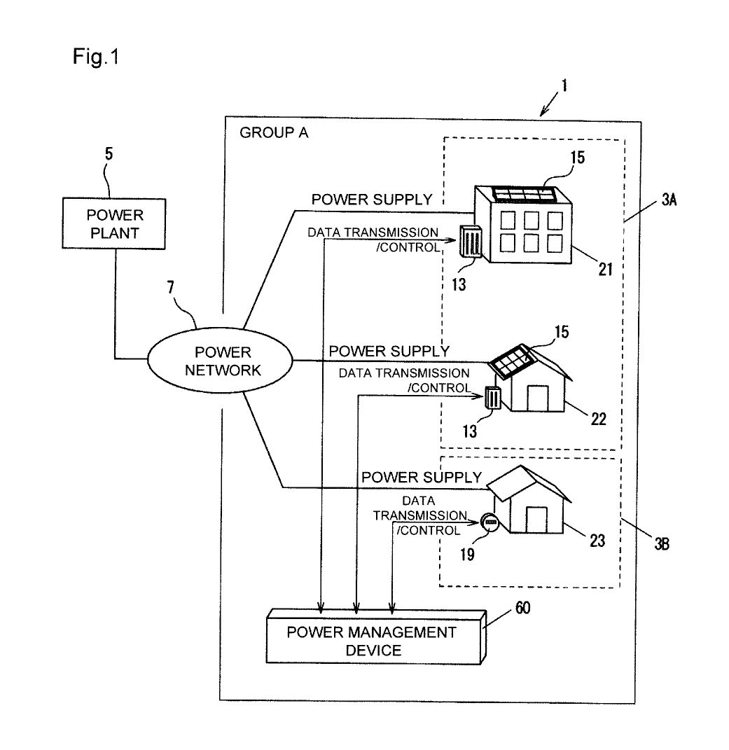

As shown in FIG. 1, an electric power management system 1 here is configured to manage power used in a building 21 and residences 22 and 23, hereinafter referred simply as “user” for example, totally. Electric power from a power plant 5 is supplied to the building 21 and the residences 22 and 23 via a power network 7. The electric power is called “grid power”.

It is noted that while only the building and the residences are shown in FIG. 1, users for example stores such as commercial facilities or industrial facilities such as factories may be included. “Group A” which the building 21 and the residences 22 and 23 belong to may be, but not limited to, a predetermined area (the area may be one region or may be regions separate from one another), for example.

The building 21 includes a power storage system 13 and a photovoltaic power generator 15. While in the present embodiment, the photovoltaic power generator 15 is illustrated as an example of a power generator, it is also possible to use other types of power generator such as a fuel cell.

A power management device, not shown, for measuring and managing information such as a power demand in the building 21 is also provided. The following managements for power and information are performed in the building 21:
(a) supplying grid power to various electronic device within the building 21,
(b) supplying power generated at the photovoltaic power generator 15 (“PV power”) to various electronic devices within the building 21,
(c) supplying power in the power storage system 13 to various electronic devices within the building 21,
(d) charging the power storage system 13 using the grid power or the PV power, and
(e) transmitting information of power demand in the building 21 to outside via a network, or the like.

In the house 22, a power storage system 13 and a photovoltaic power generator 15 are provided, as with the building 21. A power management device, not shown, for measuring and managing information of power demand, or the like, is also provided. The following managements of power and information are performed in the house 22:
(a) supplying grid power to various electronic device within the house 22,
(b) supplying power generated at the photovoltaic power generator 15 to various electronic device within the house 22,
(c) supplying power from the power storage system 13 to various electronic device within the house 22,
(d) charging the power storage system using the grid power or the PV power, and
(e) transmitting information of power demand, or the like, of the house 22 to outside for example via a network.

In the house 23, an power storage system 13, a photovoltaic power generator 15 and the like are not provided, but only a power monitor 19 is provided. The following managements of power and information are performed in the house 23:
(a) supplying grid power to various electronic device within the house, and
(e) transmitting information of power demand, or the like, of the house 23 to outside for example via a network.

It is noted that, concerning the above-described (e), it is also possible that power management device, not shown, or power monitor 19 itself transmit information by using network connection function provided therein. Alternatively, the information may be transmitted to outside for example via a server disposed within the building or the house.

As shown in FIG. 1, a group power management system 1 includes a power management device 30 for managing power within the group A totally. The power management device 30 may be one having, for example, a computer for a server, or the like. The power management device 30 has the following functions:
(a) a function of obtaining power demand in the houses 22 and 23 and the building 21 within the group A,
(b) a function of obtaining peak cut power,
(c) a function of deciding power to be discharged from all power storage systems within the group A for each time segment, and
(d) a function of deciding an index indicating an amount of grid power previously consumed within the group A (referred to as a “grid power consumption index”).

Concerning (a), for example, the power management device 30 may obtain the power demand by receiving information transmitted from each user and adding these information. Concerning (b), peak cut power may be determined by user inputting the information to the power management device 30 or by automatic input where information relating peak cut power being automatically input from another device connected to the power management device 30.

The power management device 30 may also have a function of determining a power usage situation within the group A or performing a demand response control (control for changing a power consumption pattern), a function of starting/stopping power supply from the power storage system, or the like.

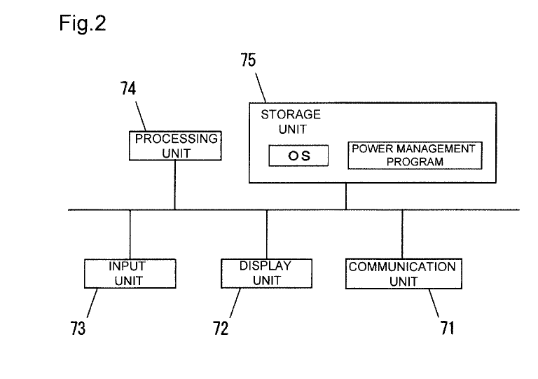

As shown in FIG. 2, the computer for a server in the device for managing electric power may be a computer which has, for example, a communication unit 71, a display unit 72, an input unit 73, a processing unit 74, a storage unit 75 and the like, where individual units are connected to one another via a bus such that they can transmit and receive data to/from one another. The communication unit 71 is configured to for example perform external communication via a network, and is realized, for example, by a network interface and the like. The display unit 72 is configured to display various data in accordance with instructions from the processing unit, and is realized, for example, by a liquid crystal display and the like. The input unit 73 is a device with which the user inputs various data, and is realized, for example, by a keyboard, a mouse and the like. The processing unit (processor) 74 is configured to conducts transmission and reception of data between the individual units via a predetermined memory, and to perform various controls. The storage unit 75 is configured to store data from the processing unit and read out the stored data, and is realized, for example, by a HDD (Hard Disk Drive), a SSD (Solid State Drive) and the like. It is noted that the individual functions of the device for managing electric power 60 as mentioned above may be achieved, for example, by the processing unit 74 executing an electric power management program in the storage unit 75.

The program, by way of example, may be stored in the storage unit of the computer in advance, may be supplied via a network such as an internet, or may be supplied to via a predetermined storage medium storing data of the program.

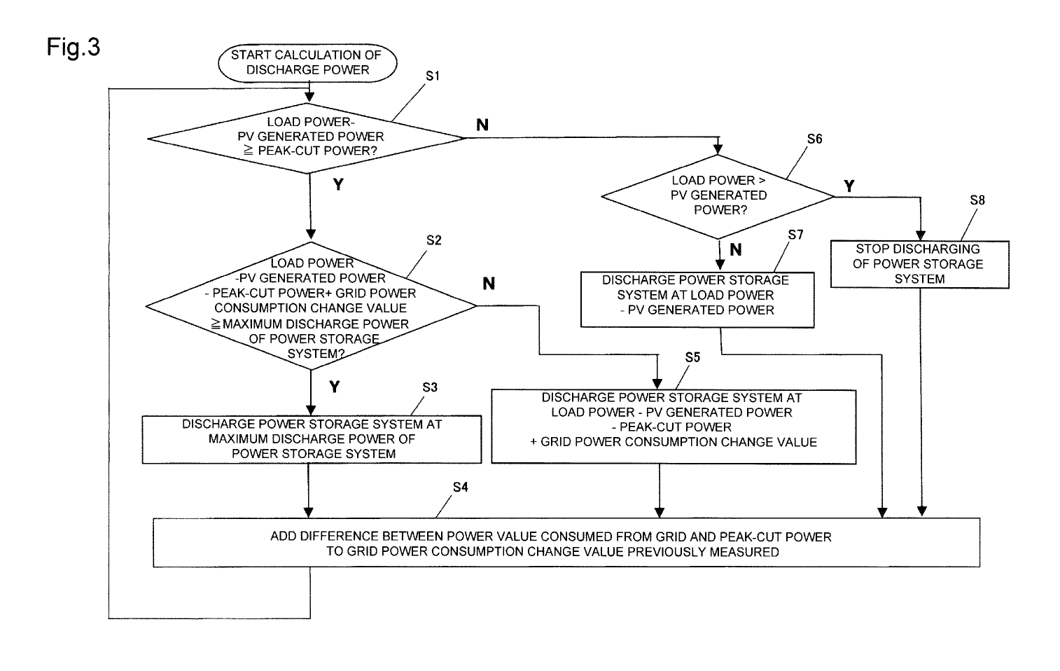

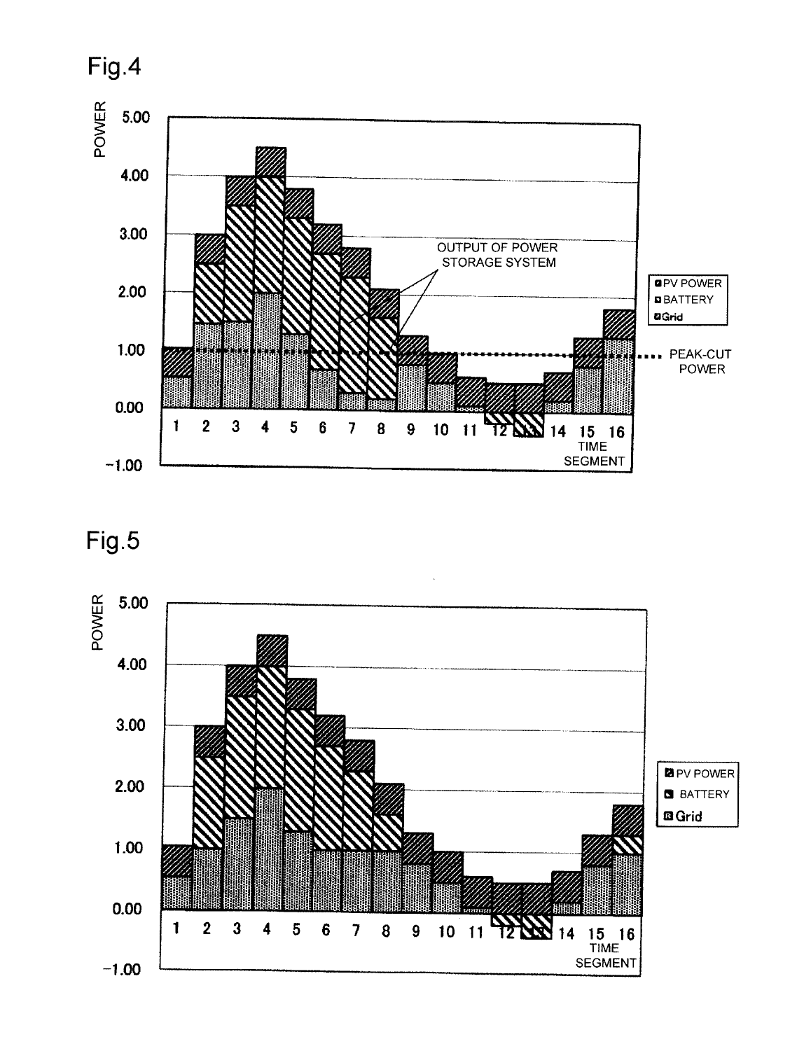

One example of a method of managing electric power in the system of the present embodiment will be described next. FIG. 3 is a flowchart illustrating a series of operation. FIG. 4 is a graph illustrating (i) change of load power for each time segment within a group, and (ii) a power supply ratio of powers from the photovoltaic power generator, the power storage system and a grid, with respect to the load power. FIG. 4 illustrates time segment in a horizontal axis and a power value in a vertical axis. Table 1 is a table indicating data of the graph in FIG. 4.

It should be noted that in the following description, “Peak cut power” is a reference electric power value at which power supply from the power storage system is started in order to cut peak of the electric power, and is herein set to be “1.00”. “Grid power consumption change value” is an index indicating an amount of grid power which has been consumed within the group before the time segment, and is initially set at “0.00”. “Discharge power of power storage system” represents electric power amount discharged from the power storage system in the group A, and its maximum output is set to be “2.00”.

### [Table 1]

TABLE 1

| | Time | | | | | | | | | | | | | | | |
|---|---|---|---|---|---|---|---|---|---|---|---|---|---|---|---|---|
| | 1 | 2 | 3 | 4 | 5 | 6 | 7 | 8 | 9 | 10 | 11 | 12 | 13 | 14 | 15 | 16 |
| Load | 1.04 | 3 | 4 | 4.5 | 3.8 | 3.2 | 2.8 | 2.1 | 1.3 | 1 | 0.6 | 0.3 | 0.1 | 0.7 | 1.3 | 1.8 |
| PV | 0.50 | 0.50 | 0.50 | 0.50 | 0.50 | 0.50 | 0.50 | 0.50 | 0.50 | 0.50 | 0.50 | 0.50 | 0.50 | 0.50 | 0.50 | 0.50 |
| Generator | | | | | | | | | | | | | | | | |
| Battery | 0.00 | 1.04 | 2.00 | 2.00 | 2.00 | 2.00 | 2.00 | 1.40 | 0.00 | 0.00 | 0.00 | −0.20 | −0.40 | 0.00 | 0.00 | |
| Up | 0.00 | 0.46 | 0.50 | 1.00 | 0.30 | 0.00 | 0.00 | 0.00 | 0.00 | 0.00 | 0.00 | 0.00 | 0.00 | 0.00 | 0.00 | 0.30 |
| Down | 0.46 | 0.00 | 0.00 | 0.00 | 0.00 | 0.30 | 0.70 | 0.80 | 0.20 | 0.50 | 0.90 | 1.00 | 1.00 | 0.80 | 0.20 | 0.00 |
| Total | −0.46 | 0.00 | 0.50 | 1.50 | 1.80 | 1.50 | 0.80 | 0.00 | −0.20 | −0.70 | −1.60 | −2.60 | −3.60 | −4.40 | −4.60 | −4.30 |
| Grid | 0.54 | 1.46 | 1.50 | 2.00 | 1.30 | 0.70 | 0.30 | 0.20 | 0.80 | 0.50 | 0.10 | 0.00 | 0.00 | 0.20 | 0.80 | 1.30 |

Description will be given below according to the flowchart.

### Time Segment “1”

First of all, in step S1, it is determined whether a value obtained by subtracting the “PV generated power” from the “load power” is equal to or greater than the “peak cut power”. In this time segment, since (load power, PV generated power, peak cut power)=(1.04, 0.50, 1.00), and the load power-the PV generated power, 1.04−0.50=0.54, being not equal to or greater than the peak cut power of 1.0, the determination in step S1 is “No”.

The flow then proceeds to step S6, it is determined whether the load power is greater than the PV generated power. In this time segment, since the load power of 1.04 is greater than the PV generated power of 0.50, the determination in step S6 is “Yes”.

As a result, as shown in FIG. 4, in the time segment “1”, the load power of 1.04 is provided by the grid power and the PV generated power, without discharging of the power storage system (step S8).

Finally, in step S4, a difference between the peak cut power value and the grid power consumption value is calculated to determine a grid power consumption change value in this time segment. Specifically, a value of −0.46, obtained by adding a difference of −0.46 between the peak cut power value of 1.00 and the grid power consumption value of 0.54 to the previous value (initial value of 0.00), is updated as the grid power consumption change value at this time point.

### Time Segment “2”

Returning to step S1 again, in the time segment “2”, since (load power, PV generated power, peak cut power)=(3.00, 0.50, 1.00), and the load power—the PV generated power, 3.00−0.50=2.50, being greater than the peak cut power of 1.0, the determination in step S1 is “Yes”.

The flow then proceeds to step S2, it is determined whether a value obtained by subtracting the PV generated power and the peak cut power from the load power and by adding the grid power consumption change value to the resultant is equal to or greater than the maximum discharge power of the power storage system. The grid power consumption change value has been calculated at −0.46 in the previous time segment (see step S4). Therefore, the result of calculation is 3.0−0.5−1.0−0.46=1.04, being not equal to or greater than 2.0 which is the maximum discharge power of the power storage system, thus, the determination in step S2 is “No”.

The flow then proceeds to step S5, power to be discharged from the power storage system is calculated. Specifically, a value obtained by subtracting the PV generated power and the peak cut power from the load power, and by adding the grid power consumption change value to the resultant is set as a power to be discharged. In this time segment, discharging is performed at 3.00−0.50−1.00−0.46=1.04.

As a result, as shown in FIG. 4, in the time segment “2”, the grid power, the power of the power storage system and the PV generated power are respectively, 1.46, 1.04 and 0.50.

Finally, in step S4, a difference of 0.46 between the peak cut value of 1.00 and the grid power consumption value of 1.46 is added to the previous value of −0.46, and then the resultant of 0.00 is updated as the grid power consumption change value in this time segment.

time segment “3”

In this time segment, discharging of the power storage system is performed at maximum output. In the time segment “3”, since (load power, PV generated power, peak cut power)=(4.00, 0.50, 1.00), and the load power—the PV generated power, 4.00−0.50=3.50, being greater than the peak cut power of 1.00, the determination in step S1 is “Yes”.

The flow then proceeds to step S2. The grid power consumption change value has been determined at 0.00 in the previous time segment (see step S4). Since the result of the calculation is 4.00−0.50−1.00−0.00=2.50, being greater than 2.00 which is the maximum discharge power of the power storage system, the determination in step S2 is “Yes”.

As a result, as shown in FIG. 4, in the time segment “3”, discharging of the power storage system is performed at maximum output of 2.00 (step S3) and the grid power and the PV generated power are respectively 1.50 and 0.50.

Finally, in step S4, a difference of 0.50 between the peak cut power value of 1.00 and the grid power consumption value of 1.50 is added to the previous value of 0.00, and the grid power consumption change value is updated with the resultant of 0.50 in this time segment.

Also in the time segments “4” to “7”, power management can be performed according to the same steps as described above.

### Time Segment “8”

In this time segment, since (load power, PV generated power, peak cut power)=(2.10, 0.50, 1.00), and the load power—the PV generated power, 2.10−0.50=1.60, being greater than the peak cut power of 1.00, the determination in step S1 is “Yes”.

The flow then proceeds to step S2. The grid power consumption change value has been determined at 0.80 in the previous time segment (see step S4). Since the result of the calculation is 2.10−0.50−1.00+0.80=1.40, being not equal to or greater than 2.00 which is the maximum discharge amount of the power storage system, the determination in step S2 is “No”.

The flow then proceeds to step S5, discharging is performed at 2.10−0.50−1.00+0.80=1.40.

The steps after step S4 are the same as those described above.

time segment “9”

The time segment “9” in which power supply from the power storage system is stopped will be described.

First of all, in step S1, since (load power, PV generated power, peak cut power)=(1.30, 0.50. 1.00), and the load power—the PV generated power, 1.30−0.50=0.80, being not equal to or greater than the peak cut power of 1.00, the determination in step S1 is “No”.

The flow then proceeds to step S6. Since in the time segment “9”, the load power of 1.30 is greater than the PV generated power of 0.50, the determination in step S6 is “Yes”.

As a result, as shown in FIG. 4, in the time segment “9”, discharging of the power storage system which has been continuously performed is stopped (step S8), and the load power of 1.30 is provided by the grid power and the PV generated power.

The steps after step S4 are the same as those described above.

Also in the time segments “10”, “11”, “14” and “15”, power management can be performed according to the same steps as those in the time segment “9”.

### Time Segments “12” and “13”

In these time segments, the power storage system is charged. Taking an example of the time segment “12”, since (load power, PV generated power, peak cut power)=(0.30, 0.50, 1.00), and the load power—the PV generated power, 0.30−0.50=−0.20, being not equal to or greater than the peak cut power of 1.00, the determination in step S1 is “No”.

The flow then proceeds to step S6. Since the load power of 0.30 is not greater than the PV generated power of 0.50, the determination in step S6 is “No”.

The flow then proceeds to step S7, since the load power—the PV generated power, 0.30−0.50=−0.20, discharging is performed at this value (the calculated value being below zero means that the power storage system is charged).

The steps after step S4 are the same as described above.

### Time Segment “16”

In this time segment, since (load power, PV generated power, peak cut power)=(1.80, 0.50, 1.00), and the load power—the PV generated power, 1.80−0.50=1.30, being greater than the peak cut power of 1.00, the determination in step S1 is “Yes”.

The flow then proceeds to step S2. The grid power consumption change value has been determined at −4.60 in the previous time segment. As a result of the calculation, since 1.80−0.50−1.00−4.60=−4.30, being not equal to or greater than 2.00 which is the maximum discharge power of the power storage system, the determination in step S2 is “No”.

The flow then proceeds to step S5, discharging is performed at 1.80−0.50−1.00−4.60=−4.30 (that is, the power storage system is charged). As a result, the load power of 1.8 is provided by the PV generated power of 0.5 and the grid power of 1.3.

According to the power management in accordance with the flowchart as described above, in the group A, it is possible to manage electric power for each time segment as shown in FIG. 4. Such a power management has the following advantages compared to the conventional methods. FIG. 5 is a graph illustrating a power supply ratio and the like for each time segment when the conventional power management is performed.

In the case of the conventional power management in FIG. 5, since the grid power and the PV power are consumed prior to the power from power storage system, for example, the grid power reaches 1.00 in the time segments “6”, “7” and “8”. In this case, load on the power plant becomes large, since a time period in which a large amount of grid power is consumed becomes long.

In contrast to this, in the case of the present embodiment, power within the group is totally managed, and power of the power storage system within the group A is determined also taking into account the “grid power consumption index”. It is therefore possible to reduce the grid power in the time segments “6”, “7” and “8”, resulting in reducing load on the power plant. Since the load on the power plant is reduced, it is not necessary to provide a large-scale power storage system at the power plant, and it is possible to realize efficient power consumption in the entire group.

While one aspect of the present invention has been described above, the present invention is not limited to the above-described embodiment, and can be modified in various ways. For example:
(a) while, in FIG. 1, a house which does not have an power storage system is included in a target for power management, it is also possible to target only houses, for example, having power storage system.
(b) while in the graph of FIG. 4 and the flowchart of FIG. 3, an example has been described where the PV power is utilized, power control as performed in the present invention is still effective in the case where the PV power cannot be utilized, such as during the night.

The present specification also discloses the following inventions:
1. A method of managing electric power for managing power supply to users within a group from a power storage system and power supply to the users from a grid, the method comprising:

obtaining a power consumed by the users (referred to as “load power”) and a peak cut power in the group;

deciding a power to be discharged from the power storage system in each time segment by using at least the load power and the peak cut power (S2, S3 and S5); and

deciding an index indicating how much grid power has been previously consumed within the group (referred to as a “grid power consumption index”) (S4),

wherein in the step of determining a power to be discharged from the power storage system (S2, S3 and S5), a power to be discharged from the power storage system is decided by using all of the grid power consumption index, the load power, and the peak cut power.

According to the above-described method, since the index indicating how much grid power was previously consumed within the group (“grid power consumption index”) is used to decide power to be discharged from the power storage system within the group, it is possible to flatten grid power within the group within a certain time range.

It should be noted that the present specification also discloses inventions in which the inventions of the above-described method 1 and the method described in the embodiment are replaced with inventions of an apparatus and a program.

### DESCRIPTION OF THE REFERENCE NUMERALS

1 POWER MANAGEMENT SYSTEM
7 POWER GRID
13 POWER STORAGE SYSTEM
15 PHOTOVOLTAIC POWER GENERATOR
19 POWER MONITOR
21 BUILDING
22, 23 HOUSE
30 POWER MANAGEMENT DEVICE

1. A power management device for managing power supply to users within a group from a power storage system and power supply to the users from a grid, the device comprising:
a unit that obtains a power consumed by the users (referred to as “load power”) and a peak cut power in the group;
a unit that decides a power to be discharged from the power storage system in each time segment by using at least the load power and the peak cut power; and
a unit that decides an index indicating how much grid power has been previously consumed within the group (referred to as a “grid power consumption index”),
wherein the unit that determines a power to be discharged from the power storage system is configured to determine a power to be discharged from the power storage system by using all of the grid power consumption index, the load power, and the peak cut power.

2. The power management device according to claim 1, wherein the grid power consumption index is a cumulative value of a difference between the grid power consumed within the group and the peak cut power.

3. The power management device according to claim 1, further comprising:
(S1) a unit that determines whether the load power is equal to or greater than the peak cut power;
(S2) a unit that, when the determination in S1 is Yes, determines whether a calculated value of [the load power−the peak cut power+the grid power consumption index] is equal to or greater than a maximum discharge power of the power storage system; and
(S3) a unit that, when the determination in S2 is Yes, causes the power storage system to discharge at maximum output.

4. The power management device according to claim 1, further comprising:
(S1) a unit that determines whether the load power is equal to or greater than the peak cut power;
(S2) a unit that, when the determination in S1 is Yes, determines whether a calculated value of [the load power−the peak cut power+the grid power consumption index] is equal to or greater than a maximum discharge power of the power storage system; and
(S5) a unit that, when judgment in S2 is No, causes the power storage system to discharge at the calculated value of [the load power−the peak cut power+the grid power consumption index].

5. The power management device according to claim 1, further comprising
(S4) a unit that,
a: sets a difference between the grid power in a time segment and the peak cut power as the grid power consumption index, when there is no grid power consumption index, and
b: updates the grid power consumption index by adding the difference between the grid power in a time segment and the peak cut power to the previous grid power consumption index, when there is the grid power consumption index.

6. The power management device according to claim 3, wherein the user further comprises a power generator, and
at least the units S1 and S2 calculate each value by also using a power from the power generator (referred to as “generated power”).

7. The power management device according to claim 6, wherein the power generator is a photovoltaic power generator.

8. A method of managing electric power for managing power supply to users within a group from a power storage system and power supply to the users from a grid, the method comprising:
obtaining a power consumed by the users (referred to as “load power”) and a peak cut power in the group;
deciding a power to be discharged from the power storage system in each time segment by using at least the load power and the peak cut power; and
deciding an index indicating how much grid power has been previously consumed within the group (referred to as a “grid power consumption index”),
wherein in the step of determining a power to be discharged from the power storage system, a power to be discharged from the power storage system is decided by using all of the grid power consumption index, the load power, and the peak cut power.

9. The method of managing electric power according to claim 8, wherein the grid power consumption index is a cumulative value of a difference between the grid power consumed within the group and the peak cut power.

10. The method of managing electric power according to claim 8, further comprising:
(S1) determining whether the load power is equal to or greater than the peak cut power;
(S2) determining, when the determination in the step S1 is Yes, whether a calculated value of [the load power−the peak cut power+the grid power consumption index] is equal to or greater than maximum discharge power of the power storage system; and
(S3) causing, when the determination in the step S2 is Yes, the power storage system to discharge at maximum output.

11. The method of managing electric power according to claim 8, further comprising:
(S1) determining whether the load power is equal to or greater than the peak cut power;
(S2) determining, when the determination in the step S1 is Yes, whether a calculated value of [the load power−the peak cut power+the grid power consumption index] is equal to or greater than maximum discharge power of the power storage system; and
(S5) causing, when judgment in the step S2 is No, the power storage system to discharge at the calculated value of [the load power−the peak cut power+the grid power consumption index].

12. The method of managing electric power according to claim 8, further comprising
(S4) a: setting a difference between the grid power in a time segment and the peak cut power as the grid power consumption index, when there is no grid power consumption index, and
b: updating the grid power consumption index by adding the difference between the grid power in a time segment and the peak cut power to the previous grid power consumption index, when there is the grid power consumption index.

13. The method of managing electric power according to claim 10, wherein the user further comprises a power generator, and
at least in steps S1 and S2 each value is calculated by also using a power from the power generator (referred to as “generated power”).

14. The method of managing electric power according to claim 13, wherein power generator is a photovoltaic power generator.

15-21. (canceled)
